(19) United States
(12) Patent Application Publication
(10) Pub. No.: US 2025/0046170 A1
(43) Pub. Date: Feb. 6, 2025

(54) ASSISTANCE CONTROL APPARATUS, ASSISTANCE CONTROL METHOD, AND COMPUTER-READABLE STORAGE MEDIUM

(71) Applicant: HONDA MOTOR CO.,LTD., Tokyo (JP)

(72) Inventors: Takahiro KUREHASHI, Saitama (JP); Moriya HORIUCHI, Saitama (JP); Yuta SAKAGAWA, Saitama (JP); Takashi OSHIMA, Saitama (JP)

(21) Appl. No.: 18/779,061

(22) Filed: Jul. 21, 2024

(30) Foreign Application Priority Data
Jul. 31, 2023 (JP) 2023-124518

(51) Int. Cl. G08B 21/02; G06V 40/20; H04W 4/40

(52) U.S. Cl. CPC G08B 21/02; G06V 40/25; H04W 4/40

(57) ABSTRACT

An assistance control apparatus comprises an information acquisition unit that acquires information indicating distance or time that a user, who is a traffic participant, moves after a user terminal associated with the user outputs a warning until movement of the user stops, a storage control unit that performs control for storing movement information indicating the distance or time that the user moves after the user terminal outputs a warning until movement of the user stops, based on the information acquired by the information acquisition unit, and a warning control unit that causes the user terminal to output a warning, wherein the warning control unit adjusts timing to cause the user terminal to output the warning based on the movement information stored by control of the storage control unit.

The contents of the following patent applications are incorporated herein by reference:
NO. 2023-124518 filed in JP on Jul. 31, 2023.

### BACKGROUND

### 1. Technical Field

The present invention relates to an assistance control apparatus, an assistance control method, and a computer-readable storage medium.

### 2. Related Art

In recent years, efforts have been intensified to provide access to a sustainable transportation system with consideration given to even vulnerable people among other traffic participants. To achieve this, research and development has been focused on to further improve traffic safety and convenience through research and development regarding a preventive safety technique. Patent documents 1-4 describes techniques related to road crossing and running-out of pedestrians.

### PRIOR ART DOCUMENTS

### Patent Documents

Patent Document 1: Japanese Patent Application Publication No. 2017-49687
Patent Document 2: Japanese Patent Application Publication No. 2019-204241
Patent Document 3: Japanese Patent Application Publication No. 2008-310376
Patent Document 4: Japanese Patent Application Publication No. 2018-151712

### BRIEF DESCRIPTION OF THE DRAWINGS

FIG. 1 schematically illustrates a usage scene of a assistance system 10.

FIG. 2 illustrates a functional configuration of an assistance apparatus 60.

FIG. 3 illustrates an example data structure of a stop record information for each user measured by a user terminal.

FIG. 4 illustrates an example data structure of a bicycle deceleration record information.

FIG. 5 illustrates an example data structure of stopping required time information.

FIG. 6 illustrates an example data structure of correction time information for the stopping required time.

FIG. 7 describes an example timing to transmit warning information to a user terminal 82.

FIG. 8 illustrates an example execution sequence of processing performed by an in-vehicle processing apparatus 40 included in an image-capturing apparatus 70, a user terminal 82, and a vehicle 20, and an assistance apparatus 60.

FIG. 9 illustrates an example of a computer 2000.

### DESCRIPTION OF EXEMPLARY EMBODIMENTS

Hereinafter, embodiments of the present invention will be described. However, the following embodiments are not for limiting the invention according to the claims. In addition, not all of the combinations of features described in the embodiments are essential to the solution of the invention.

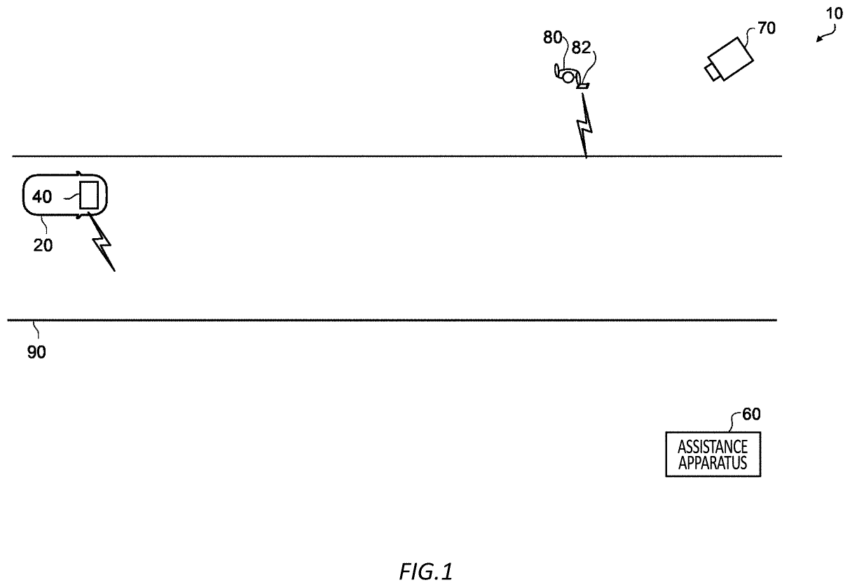

FIG. 1 schematically illustrates a usage scene of a assistance system 10. The assistance system 10 includes a vehicle 20, a user terminal 82, an assistance apparatus 60, and an image-capturing apparatus 70.

The vehicle 20 includes an in-vehicle processing apparatus 40. The user terminal 82 is a terminal possessed by a user 80. In the present embodiment, the user 80 is a pedestrian.

The vehicle 20 is a vehicle that is traveling on a road 90. The vehicle 20 is an example of a mobile object. The in-vehicle processing apparatus 40 includes a functionality to communicate with the outside by using mobile communication. The in-vehicle processing apparatus 40 is configured to include sensors such as a location sensor including a global navigation satellite system (GNSS) receiver, a speed sensor such as a vehicle speed sensor, a distance measuring sensor that measures the distance from the vehicle 20 to surrounding objects. The in-vehicle processing apparatus 40 includes a functionality to process the information acquired by various types of sensor included in the in-vehicle processing apparatus 40, and a functionality to communicate with the assistance apparatus 60. The in-vehicle processing apparatus 40 provides an advanced driving assistance system (ADAS) functionality included in the vehicle 20.

The user terminal 82 is a portable terminal such as a smartphone, for example. The user terminal 82 is an example of a mobile object. The user terminal 82 periodically transmits, to the assistance apparatus 60, current location information of the user terminal 82 detected by the location sensor including the GNSS receiver.

The image-capturing apparatus 70 is an image-capturing apparatus provided on a traffic infrastructure. The image-capturing apparatus 70 acquires locations of the vehicle 20 and the user 80 that exist in the image-capturing range of the image-capturing apparatus 70 by analyzing the captured image, and transmits the acquired locations of the vehicle 20 and the user 80 to the assistance apparatus 60.

The assistance apparatus 60 receives, through mobile communication, information transmitted from the in-vehicle processing apparatus 40, the user terminal 82, and the image-capturing apparatus 70. The assistance apparatus 60 may receive the information transmitted from the in-vehicle processing apparatus 40, the user terminal 82, and the image-capturing apparatus 70 through any combination n mobile communication and communication lines such as the Internet and dedicated lines. The assistance apparatus 60 performs traffic assistance for traffic participants based on the information received from the in-vehicle processing apparatus 40, the user terminal 82, and the image-capturing apparatus 70.

In the present embodiment, the it can be assumed that the user 80 exists within a predetermined range from the location of the user terminal 82. For example, the location of the user terminal 82 may be considered as the location of the user 80.

Based on the location information history of the user terminal 82 and road information including location information of the road 90, for example, when it is determined that the user terminal 82 is moving toward the road 90, the assistance apparatus 60 predicts the location of the user terminal 82 and the vehicle 20 at the time when the user terminal 82 reached the road 90, based on the location information history of the user terminal 82 and the vehicle 20 and the map information. When the distance between the location of the user terminal 82 and the location of the vehicle 20 at the time when the user terminal 82 reached the road 90 is shorter than a predetermined distance, the assistance apparatus 60 determines that the user terminal 82 and the vehicle 20 are approaching each other, and transmits, to the user terminal 82, warning information instructing the user terminal 82 to output a warning.

The assistance apparatus 60 acquires the time it takes for the user 80 to stop after the user terminal 82 outputs the warning. The time it takes for the user 80 to stop after the user terminal 82 outputs the warning may be referred to as a stopping required time. The assistance apparatus 60 may acquire the stopping required time from the user terminal 82. The assistance apparatus 60 may acquire the stopping required time estimated from the location information history of the user terminal 82. The assistance apparatus 60 may acquire the stopping required time according to the age of the user 80. The assistance apparatus 60 adjusts the timing to transmit the warning information to the user terminal 82, by taking into account the stopping required time of the user terminal 82. For example, the longer the stopping required time, the earlier the timing to transmit the warning information to the user terminal 82 becomes. In this manner, according to the assistance system 10, the timing to transmit the warning information can be adjusted such that the user 80 can safely stop, by taking into account the stopping required time for each of the users 80.

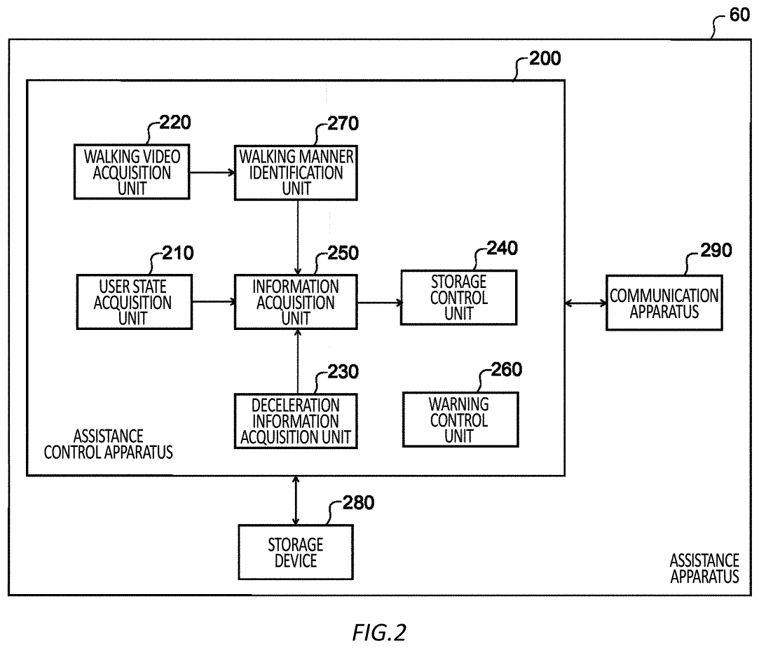

FIG. 2 illustrates a functional configuration of an assistance apparatus 60. The assistance apparatus 60 includes an assistance control apparatus 200, a communication apparatus 290, and a storage device 280.

The communication apparatus 290 is responsible for communication between each of the in-vehicle processing apparatus 40, the user terminal 82, and the image-capturing apparatus 70 and the assistance apparatus 60, based on control by the assistance control apparatus 200. The assistance control apparatus 200 is achieved by being provided with a circuitry such as an arithmetic processing apparatus including a processor, for example. The assistance control apparatus 200 may be achieved by a microcomputer provided with a CPU, a ROM, a RAM, an I/O, a bus, and the like. The storage device 280 is achieved by being provided with a non-volatile storage medium. The assistance control apparatus 200 performs processing by using the information stored in the storage device 280. The storage device 280 may store map information. The map information stored in the storage device 280 may be used by the assistance control apparatus 200.

The assistance control apparatus 200 includes a user state acquisition unit 210, an information acquisition unit 250, a storage control unit 240 deceleration information collection unit 230, a walking video information acquisition unit 220, a walking manner identification unit 270, and a warning control unit 260. Note that, a form in which the assistance apparatus 60 does not have some of the functionalities in the functional configuration illustrated in FIG. 2 may be adopted.

The information acquisition unit 250 acquires information indicating the distance or time that the user 80 moves after the user terminal 82 associated with the user 80 who is a traffic participant, outputs a warning until movement of the user 80 stops. The storage control unit 240 performs control to store movement information indicating the distance or time that the user 80 moves after the user terminal 82 outputs the warning until the movement of the user 80 stops, based on the information acquired by the information acquisition unit 250. The warning control unit 260 causes the user terminal 82 to output a warning. The warning control unit 260 adjusts timing to cause the user terminal 82 to output the warning, based on the movement information stored through control from the storage control unit 240.

The information acquisition unit 250 may acquire information indicating the distance or time that the user 80 moves after the user terminal 82 outputs a warning until the movement of the user 80 stops, acquired by the user terminal 82 after the warning control unit 260 caused the user terminal 82 to output the warning. The information acquisition unit 250 may acquire step count information of the user 80 counted by the user terminal 82 after the user terminal 82 outputs a warning until the movement of the user terminal 82 stop, which is acquired by the user terminal 82 after the warning control unit 260 caused the user terminal 82 to output the warning.

The user state acquisition unit 210 may acquire state information indicating whether the user 80 is in a walking state or in a traveling state. The information acquisition unit 250 may acquire, for each of the walking state and the traveling state, information indicating the distance or time that the user 80 moves after the user terminal 82 outputs the warning until the movement of the user 80 stops. The storage control unit 240 may perform control to store the movement information based on the information acquired by the information acquisition unit 250 in association with the state information acquired by the user state acquisition unit 210. The warning control unit 260 may adjust the timing to cause the user terminal 82 to output the warning based on the movement information stored in association with the state information acquired by the user state acquisition unit 210.

The user state acquisition unit 210 may acquire state information indicating whether the user 80 is in a state of traveling on a bicycle. When the user 80 is in a state of traveling on a bicycle, the information acquisition unit 250 may acquire information indicating the distance or time that the user 80 moves after the user terminal 82 outputs the warning until the movement of the user 80 stops. The storage control unit 240 may perform control to store the movement information based on the information acquired by the information acquisition unit 250 in association with the state information acquired by the user state acquisition unit 210. The warning control unit 260 may adjust the timing to cause the user terminal 82 to output the warning based on the information stored in association with the state information acquired by the user state acquisition unit 210.

The deceleration information collection unit 230 may collect information indicating the deceleration rate from a state in which the user 80 is traveling on the bicycle until the bicycle stops by braking. The information acquisition unit 250 may acquire information indicating the distance or time that the user 80 moves after the user terminal 82 outputs a warning until the movement of the user 80 stops, based on the deceleration rate exceeding a predetermined reference value, among the deceleration rates collected by the deceleration information collection unit 230.

The user state acquisition unit 210 may acquire state information indicating a physical or mental state of the user 80. The information acquisition unit 250 may acquire, for each of the state information acquired by the user state acquisition unit 210, information indicating the distance or time that the user 80 moves after the user terminal 82 outputs a warning until the movement of the user 80 stops. The storage control unit 240 may perform control to store the movement information based on the information acquired by the information acquisition unit 250 in association with the state information acquired by the user state acquisition unit 210 The warning control unit 260 may adjust the timing to cause the user terminal 82 to output the warning based on the movement information stored in association with the state information acquired by the user state acquisition unit 210.

The storage control unit 240 may perform control to increase the distance indicated by the movement information that is already stored, according to aging of the user 80.

The walking video information acquisition unit 220 may acquire video information of the user 80 walking. The walking manner identification unit 270 may identify a walking manner of the user 80 identified from the video information acquired by the walking video information acquisition unit 220. The information acquisition unit 250 may acquire the distance or time associated with the walking manner of the user 80 identified by the walking manner identification unit 270 as the information indicating the distance or time.

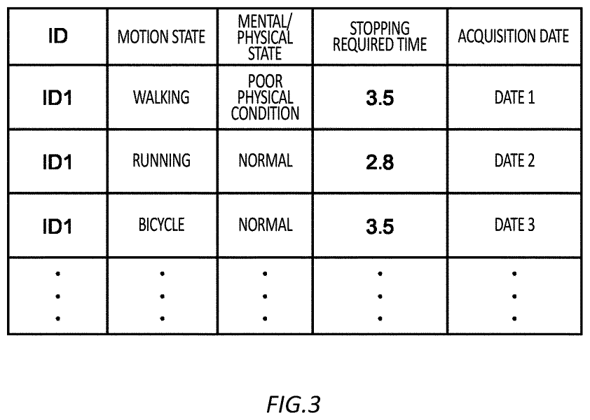

FIG. 3 illustrates an example data structure of stop record information for each user measured by the user terminal. For example, the stop record information is information indicating the time measured by the user terminal 82 after the user terminal 82 outputs a warning until walking of the user 80 stops. The assistance apparatus 60 stores, in the storage device 280, the information transmitted from the user terminal 82 as the stop record information.

The stop record information includes, as data items, an ID, a motion state, a mental/physical state, a stopping required time, and an acquisition date. The ID is identification information of the user terminal 82. The motion state is information indicating whether the user 80 is walking, running, or traveling on a bicycle.

For example, the mental/physical state includes information indicating normal, poor physical condition, drunk, and impatient. The mental/physical state is information indicating a mental or physical state. The stopping required time is the time required for the user 80 to stop after the user terminal 82 output a warning, which is measured by the user terminal 82.

The acquisition date may be information indicating the date at which the assistance apparatus 60 acquired the stop record information data. The data for the ID, the motion state, the mental/physical state, and the stopping required time may be acquired by the information acquisition unit 250.

The motion state may be determined by the user terminal 82. The motion state of the user 80 may be determined based on the speed, angular speed, and location information of the user terminal 82. At least a part of the motion state may be determined by analyzing the image acquired from the image-capturing apparatus 70, and transmitted to the assistance apparatus 60 together with the location information of the user 80 acquired by analyzing the image. The assistance apparatus 60 may identify which of the user terminal 82 the motion state of the user 80 transmitted from the image-capturing apparatus 70 belongs to by matching the location information of the user terminal 82 transmitted from the image-capturing apparatus 70 with the location information of the user terminal 82.

The mental/physical state is determined by the user terminal 82. At least a part of the mental/physical state may be determined at the user terminal 82 based on the information acquired by the sensor that detects bio-information of the user 80. At least a part of the mental/physical state may be determined from the expression, posture or the like of the user 80 by analyzing the image acquired from the image-capturing apparatus 70, and transmitted to the assistance apparatus 60 together with the location information of the user 80.

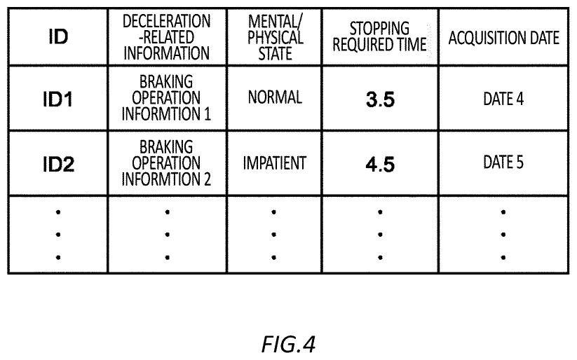

FIG. 4 illustrates an example data structure of the bicycle deceleration record information. The bicycle deceleration record information is information acquired when the user 80 brakes to stop, in a case where the user 80 is riding a bicycle and a warning is not output from the user terminal 82. The assistance apparatus 60 acquires, in the storage device 280, the information transmitted from the user terminal 82 as the bicycle deceleration record information.

The bicycle deceleration record information includes, as data items, an ID, a deceleration-related information, a mental/physical state, a stopping required time, and an acquisition date. The ID is identification information of the user terminal 82.

The deceleration-related information is information related to deceleration caused by braking operation. For example, the user terminal 82 may acquire, through wireless communication based on communication standards such as Bluetooth (registered trademark) or ANT+ (registered trademark), braking operation information detected by a grip strength sensor installed on a handle of the bicycle, and transmit the acquired information to the assistance apparatus 60 as the deceleration-related information.

When information from the grip strength sensor or the like is not acquired, the user terminal 82 transmits the deceleration rate information to the assistance apparatus 60 as the deceleration-related information. The deceleration rate information may be at least any of chronological information of the speed detected by the speed sensor, chronological information of the deceleration rate detected by the acceleration sensor, and/or the speed at the time of the start of deceleration and the stopping time.

The mental/physical state includes, for example, information indicating normal, poor physical condition, drunk, and impatient/

The mental/physical state is information indicating a mental or physical state. The stopping required time is the time required to stop after the deceleration started when traveling on the bicycle, which is measured by the user terminal 82. The stopping required time may be measured based on the location information detected by the user terminal 82 and the information detected by the acceleration sensor included in the user terminal 82. The user terminal 82 may acquire, through wireless communication, the information detected by a sensor (for example, a speed sensor) that detects wheel rotation of the bicycle, and measure the stopping required time based on the acquired information.

The acquisition date may be information indicating the date at which the assistance apparatus 60 acquired the bicycle deceleration record information data. Data of the ID, the deceleration-related information, the mental/physical state, and the stopping time may be acquired by the information acquisition unit 250.

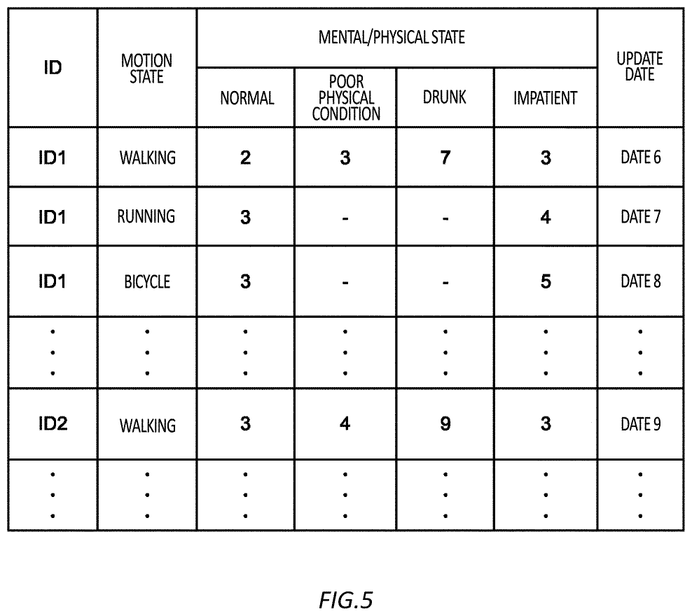

FIG. 5 illustrates an example data structure of the stopping required time information. The stopping required time information is stored in the storage device 280. The stopping required time information is an example of movement information indicating the distance or time that the user 80 moves after the user terminal 82 outputs a warning until the movement of the user 80 stops.

The stopping required time information is information generated by integrating the stop record information and the bicycle deceleration record information described in connection to FIG. 3 and FIG. 4. The stopping required time information is stored in the storage control unit 240. The stopping required time information includes, as data items, the ID and motion state, the mental/physical state including “normal”, “poor physical condition”, “drunk”, and “impatient”, and an update date.

The ID is identification information of the user terminal 82. The motion state is information indicating whether the user 80 is walking, running, or traveling on a bicycle. “Normal”, “poor physical condition”, “drunk”, and “impatient” are each information indicating the mental/physical state. The update date may be information indicating the date at which the assistance apparatus 60 updated the data for each of the stopping required time.

The storage control unit 240 calculates, for each ID, the stopping required time corresponding to the combination of the motion state “walking” and mental/physical state “normal”, by referring to the stop record information and averaging the stopping required time associated with the combination of the motion state “walking” and mental/physical state “normal” for each ID. Similarly for combinations with the motion state “walking” of other mental/physical states “poor physical condition”, “drunk”, and “impatient”, the storage control unit 240 calculates the stopping required time corresponding to each combination by referring to the stop record information and averaging the stopping required time associated with the combination of the motion state “walking” and each of the mental/physical states for each ID. In this manner, the storage control unit 240 calculates the stopping required time corresponding to each of the combinations of the ID, the motion state “walking”, and the mental/physical state, and stores the calculated stopping required time as the stopping required time information data.

Also for the motion state “running”, through similar processing, the storage control unit 240 calculates the stopping required time corresponding to each of the combinations of the ID, the motion state “running”, and the mental/physical states, and stores the calculated stopping required time as the stopping required time information data.

The storage control unit 240 can calculate the stopping required time corresponding to the motion state “bicycle” and each mental/physical state with the same method as the calculation method for the stopping required time corresponding to the motion state “walking”.

Next, a method for calculating the stopping required time corresponding to the motion state “bicycle” based on the deceleration record information will be described. The stopping required time in the present embodiment is the time it takes for the movement of the user 80 to stop after the warning is output. Since it is assumed that sudden braking is applied when a warning is output, the stopping required time corresponding to the motion state “bicycle” is desirably decided based on the time it takes for the movement of the user 80 to stop when sudden braking is applied.

Therefore, the storage control unit 240 extracts the stopping time when it is determined that sudden braking has been applied, among the stopping time included in the deceleration record information, and decides the stopping required time corresponding the motion state “bicycle” based on the extracted stopping time.

Whether sudden braking has been applied may be determined based on the deceleration-related information. For example, when braking operation information is included in the deceleration-related information, by statistically processing data for the combinations of the grip strength detected by the grip strength sensor and the stopping time, the data may be classified into a set of data including an average combination, and a set of data associated with a combination of a grip strength that is higher than a predetermined value and a stopping time that is shorter than a predetermined value, and the data that belongs to the latter set of data may be considered to be the data obtained when it is determined that sudden braking has been applied.

When the braking operation information is not included in the deceleration-related information, whether sudden braking has been applied may be determined based on the deceleration-related information. For example, by statistically processing data for the combinations of the deceleration rate and the stopping time, the data may be classified into a set of data including an average combination, and a set of data associated with a combination of a deceleration rate that is higher than a predetermined value and a stopping time that is shorter than a predetermined value, and the data that belongs to the latter set of data may be considered to be the data obtained when it is determined that sudden braking has been applied.

By extracting the stopping time when it is determined that sudden braking has been applied and using the extracted stopping time to average the stopping time corresponding to each of the mental/physical state for each ID, the storage control unit 240 calculates the stopping required time corresponding to each of the combinations of the ID, the motion state “bicycle”, and mental/physical states, and stores the calculated stopping required time as stopping required time information data.

In this manner, the stopping required time associated with the motion state “bicycle” in the stopping required time information may be calculated from the stop record information and the deceleration record information. The stopping required time associated with the motion state “bicycle” in the stopping required time information may be calculated by using both of the stopping required time calculated from the stop record information and the stopping required time calculated from the deceleration record information. The stopping required time calculated from the deceleration record information may be used to complement the stopping required time calculated from the stop record information.

The warning control unit 260 refers to the stopping required time information to adjust the timing to transmit the warning information to the user terminal 82. For example, when the identification information of the user terminal 82 is “ID1”, the user 80 is in a walking state, and the mental/physical state of the user 80 is “normal”, the stopping required time of the user 80 is decided to be “two seconds”. This means that it takes about two seconds for the user 80 to stop after the user terminal 82 output a warning. Therefore, the warning control unit 260 advances the timing to transmit the warning information to the user terminal 82 by “two seconds”.

The storage control unit 240 may update the stopping required time each time a predetermined time elapses, and/or each time new data is added to the stop record information and/or the deceleration record information. The storage control unit 240 may increase the stopping required time stored in the stopping required time information according to aging of the user 80, each time a predetermined time elapses. In this manner, the stopping required time can be increased according to aging of the user 80. The amount by which the stopping required time is increased may be decided by taking into account the variation over time of the stopping required time, based on the stopping required time for the user 80 and the date that are stored in the stop record information. The amount by which the stopping required time is increased may be decided by taking into account the variation over time of the stopping required time of a plurality of users, based on the stopping required time for the plurality of users and the date that are stored in the stop record information. The amount by which the stopping required time is increased may be set according to the age of the user 80 registered through the user terminal 82.

As described in connection to FIG. 3 to FIG. 5, the stopping required time associated with the motion state “walking” in the stopping required time information may be calculated from the stop record information. The stopping required time associated with the motion state “walking” in the stopping required time information may be acquired based on the video information of the user 80 walking. For example, the walking video information acquisition unit 220 acquires video information of the user 80 walking captured by the user terminal 82 or the image-capturing apparatus 70. The walking manner identification unit 270 identifies the walking manner of the user 80 identified from the video information acquired by the walking video information acquisition unit 220. The walking manner may be a posture, a stride length, a footwork speed, and the like. The walking manner may be associated with the stopping required time in advance. For example, when a walking posture of the user is classified into a forward-leaning posture, a longer time may be set for the stopping required time associated with the forward-leaning posture as the walking posture of the user than the stopping required time associated with a normal posture. The information acquisition unit 250 may acquire the information indicating the time associated with the walking manner of the user 80 identified by the walking manner identification unit 270 as the stopping time information. By a similar approach, the stopping required time associated with the motion state “running” in the stopping required time information may be acquired based on the video information in which the user 80 running is captured.

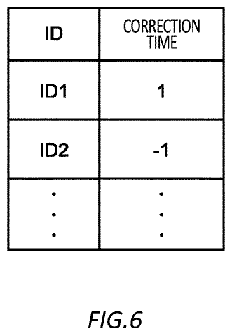

FIG. 6 illustrates an example data structure of correction time information for the stopping required time. The correction time information is stored in the storage device 280.

The correction time information includes the ID and correction time, as data items. The ID is identification information of the user terminal 82. The correction time is a correction value for correcting the stopping required time. The correction time can be set by the user 80. The storage control unit 240 changes the correction time associated with the identification information of the user terminal 82 based on an instruction from the user terminal 82.

For example, when the identification information of the user terminal 82 is “ID1”, the warning control unit 260 decides the correction time for the stopping required time to be “one second”. In this case, the warning control unit 260 adds one second to the stopping required time (for example, “two seconds”) that is decided from the information during movement illustrated in FIG. 5. Therefore, the warning control unit 260 advances the timing to transmit the warning information by (stopping required time+one second).

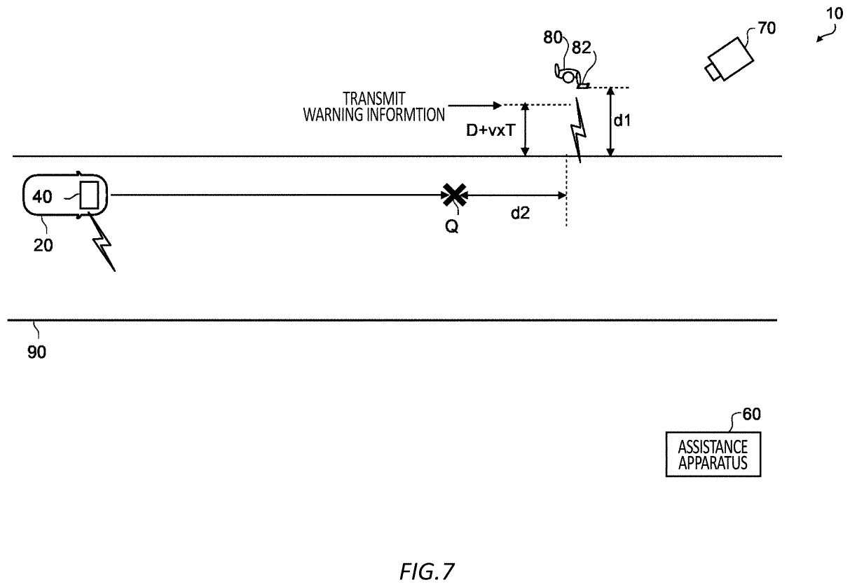

FIG. 7 describes an example timing to transmit warning information to the user terminal 82. When it is determined that the user terminal 82 is moving toward the road 90 based on the location information history of the user terminal 82, the warning control unit 260 predicts time t it takes for the user terminal 82 to reach the road 90. For example, the warning control unit 260 predicts time t based on the moving speed v of the user terminal 82 estimated based on the location information history of the user terminal 82 and the distance d1 from the current location of the user terminal 82 to the road 90.

The warning control unit 260 predicts the location Q of the vehicle 20 at the timing after time t has elapsed from the current time, based on the speed of the vehicle 20 estimated from the location information history of the vehicle 20 and the current location of the vehicle 20. The warning control unit 260 calculates a distance d2 between the location of the user terminal 82 and the location Q of the vehicle 20 in the moving direction of the vehicle 20 at the timing after time t has elapsed. When d2 is shorter than a predetermined value, the warning control unit 260 determines that the vehicle 20 and the user terminal 82 are approaching each other, and determines to transmit the warning information to the user terminal 82.

The warning control unit 260 identifies the stopping required time T of the user 80 with the approach described in connection to FIG. 5, FIG. 6 and the like. At this time, the warning control unit 260 may identify the motion state and the mental/physical state of the user 80 based on the information detected or set at the user terminal 82 and/or the information detected at the image-capturing apparatus 70. For example, when the stopping required time of the user 80 identified from the stopping required time information in FIG. 5 is two seconds, and the correction time for the user 80 identified from the correction time information in FIG. 6 is one second, the warning control unit 260 sets the stopping required time T to three seconds.

In this case, the warning control unit 260 decides to cause the user terminal 82 to transmit the warning information at the timing when the location of the user terminal 82 has reached a location located before the road 90 by at least v×T. Practically, by setting the distance margin defined by taking into account the detection accuracy of the location of the user terminal 82 or the like as D, the user terminal 82 is caused to transmit the warning information at the timing when the distance from the current location of the user terminal 82 to the road 90 becomes D+v×T.

In this manner, a warning can be transmitted to the user 80 at the timing where there is enough margin for the distance (v×T) by which the user 80 advances before stopping after noticing the warning. Therefore, the warning information can be transmitted, securing the safety of the user 80.

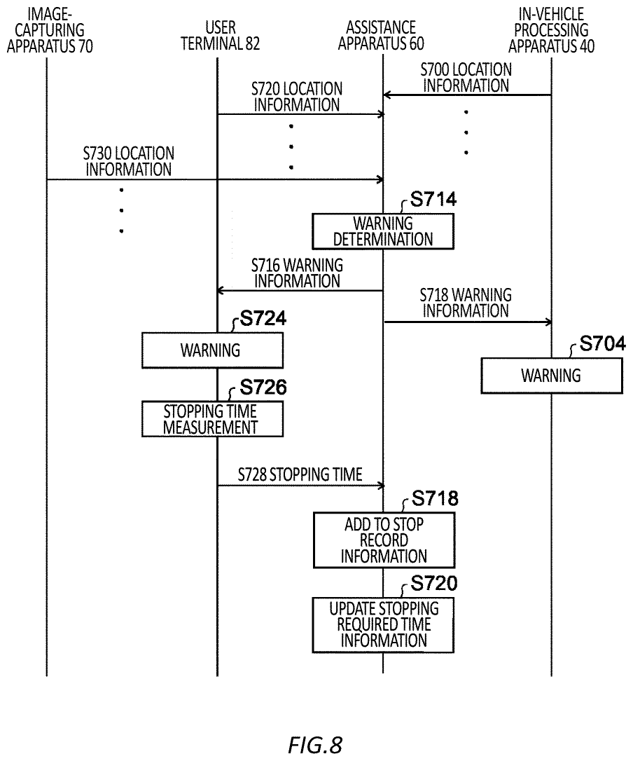

FIG. 8 illustrates an example execution sequence of processing performed by an in-vehicle processing apparatus 40 included in an image-capturing apparatus 70, a user terminal 82, and a vehicle 20, and an assistance apparatus 60.

At S700, the in-vehicle processing apparatus 40 transmits the location information of the vehicle 20 to the assistance apparatus 60. Transmission of the location information from the in-vehicle processing apparatus 40 to the assistance apparatus 60 is performed periodically.

At S720, the user terminal 82 transmits, to the assistance apparatus 60, the location information indicating the current location of the user terminal 82 based on a signal received from a GNSS satellite. Transmission of the location information from the user terminal 82 to the assistance apparatus 60 is performed periodically. The user terminal 82 may transmit, to the assistance apparatus 60, the motion state and/or the mental/physical state of the user 80 detected or set at the user terminal 82.

At S730, the image-capturing apparatus 70 transmits, to the assistance apparatus 60, location information indicating the location of the user 80 obtained by analyzing an image captured by the image-capturing apparatus 70. Transmission of the location information from the image-capturing apparatus 70 to the assistance apparatus 60 is performed periodically. The image-capturing apparatus 70 may further transmit, to the assistance apparatus 60, information indicating the motion state and/or the mental/physical state of the user 80 acquired by analyzing the image.

At S714, control unit 260 of the assistance apparatus 60 determines whether to cause the user terminal 82 to output a warning. For example, the warning control unit 260 determines whether to cause the user terminal 82 to output a warning by the approach described in connection to FIG. 7.

When it is determined that the user terminal 82 is to be caused to output a warning, at S716, the warning control unit 260 transmits, to the user terminal 82, warning information instructing the user terminal 82 to output a warning by controlling the communication apparatus 290. Further, at S718, the warning control unit 260 transmits, to the in-vehicle processing apparatus 40, warning information instructing the in-vehicle processing apparatus 40 to output a warning by controlling the communication apparatus 290.

When the warning information from the assistance apparatus 60 is received at the in-vehicle processing apparatus 40, at S704, a warning indicating that a user approaching the vehicle 20 exists is output through an HMI (Human Machine Interface) functionality of the in-vehicle processing apparatus 40, to notify the occupant of the vehicle 20. The in-vehicle processing apparatus 40 may notify the occupant of the vehicle 20 by means of sound, and displaying on a display apparatus included in the vehicle 20, that a vehicle approaching the vehicle 20 exists.

Upon receiving the warning information from the assistance apparatus 60, at S724, the user terminal 82 notifies the user 80 by outputting a warning that a vehicle 20 approaching the user 80 exists through the HMI functionality of the user terminal 82. The user terminal 82 may output the warning information that a vehicle approaching the user 80 exists by sound.

At S726, the user terminal 82 measures the stopping time after the warning is output at S724 until the movement of the user terminal 82 stops. At S728, the stopping time measured at S726 is transmitted to the assistance apparatus 60.

At S718, the warning control unit 260 adds data indicating the stopping time acquired at S728 to the stop record information. At S720, the warning control unit 260 updates the stopping required time information.

In connection to FIG. 3 and FIG. 8, the approach for calculating the time after the user terminal 82 outputs the warning until the movement of the user 80 stops and the approach for using said time for transmission of the warning information have been mainly described. Since the distance by which the user 80 moves can be calculated with the speed of the user 80 and the time, a similar approach can be applied to an approach for calculating the distance that the user 80 moves after the user terminal 82 outputs the warning until the movement of the user 80 stops, as well as to an approach for using said distance for transmission of the warning information. Further, since the distance that the user 80 moves can be calculated from the step count and stride length of the user 80, assuming that the stride length of the user 80 is known or the stride length of the user 80 is a prescribed value, a similar approach can be applied to an approach for calculating the step count of the user 80 after the user terminal 82 outputs the warning until the movement of the user 80 stops, as well as to an approach for using said step count for transmission of the warning information.

According to the assistance system 10 described above, the timing to transmit the warning information to each user can be adjusted for each user by taking into account the distance or time that the user moves after the warning is output until the movement of each user stops. Thus, it can also be said that the timing to transmit the warning information to each user can be delayed for each user as long as security can be secured. By delaying the timing to transmit the warning information, the movement of the user can be assessed thoroughly, which can reduce the possibility of transmitting unnecessary warning information and enhance the accuracy of the warning.

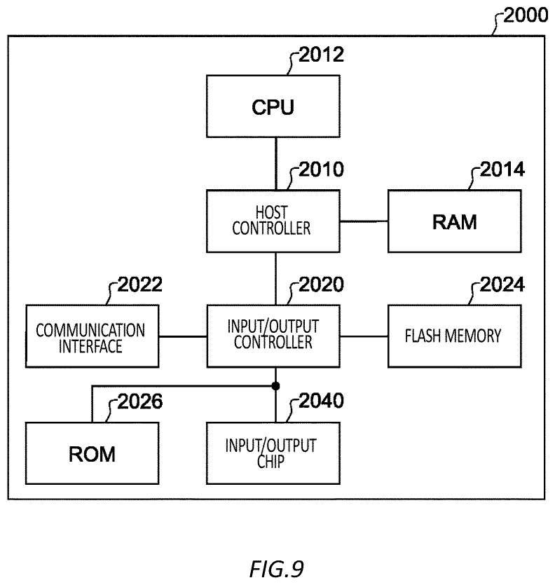

FIG. 9 illustrates an example of a computer 2000 where a plurality of embodiments of the present invention may be entirely or partially embodied. A program installed in the computer 2000

can cause the computer 2000 to function as an apparatus such as the assistance apparatus 60 according to the embodiments or each unit of the apparatus, to perform an operation associated with the apparatus or each unit of the apparatus, and/or to perform a process or a step of the process according to the embodiments. Such a program may be executed by a CPU 2012 in order to cause the computer 2000 to execute a specific operation associated with some or all of the processing procedures and the blocks in the block diagrams described herein.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to programs stored in the ROM 2026 and the RAM 2014, and thereby controls each unit.

The communication interface 2022 communicates with another electronic device via a network. The flash memory 2024 stores a program and data used by the CPU 2012 in the computer 2000. The ROM 2026 stores a boot program or the like executed by the computer 2000 during activation, and/or a program depending on hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a USB port, a HDMI (registered trademark) port.

A program is provided via a network or a computer-readable storage medium such as a CD-ROM, a DVD-ROM, or a memory card. The RAM 2014, the ROM 2026, or the flash memory 2024 are examples of the computer-readable storage medium. The program is installed in the flash memory 2024, the RAM 2014, or the ROM 2026, and executed by the CPU 2012. Information processing written in these programs is read by the computer 2000, and provides cooperation between the programs and the various types of hardware resources described above. An apparatus or a method may be configured by achieving operations or processing of information depending on a use of the computer 2000.

For example, when a communication is executed between the computer 2000 and an external device, the CPU 2012 may execute a communication program loaded in the RAM 2014, and instruct the communication interface 2022 to execute communication processing based on processing written in the communication program. Under the control of the CPU 2012, the communication interface 2022 reads transmission data stored in a transmission buffer processing region provided in a recording medium such as the RAM 2014 or the flash memory 2024, transmits the read transmission data to the network, and writes reception data received from the network into a reception buffer processing region or the like provided on the recording medium.

In addition, the CPU 2012 may cause all or a necessary portion of a file or a database stored in a recording medium such as the flash memory 2024 to be read into the RAM 2014, and execute various kinds of processing on the data on the RAM 2014. Next, the CPU 2012 writes back the processed data into the recording medium.

Various types of information such as various types of programs, data, a table, and a database may be stored in the recording medium and may be subjected to information processing. The CPU 2012 may execute, on the data read from the RAM 2014, various kinds of processing including various kinds of operations, information processing, conditional judgement, conditional branching, unconditional branching, information retrieval/replacement, or the like described herein and specified by instruction sequences of the programs, and write back a result into the RAM 2014. In addition, the CPU 2012 may retrieve information in a file, a database, or the like in the recording medium. For example, when multiple entries each having an attribute value of a first attribute associated with an attribute value of a second attribute, is stored in the recording medium, the CPU 2012 may retrieve an entry having a designated attribute value of the first attribute that matches a condition from these multiple entries, and read the attribute value of the second attribute stored in this entry, thereby obtaining the attribute value of the second attribute associated with the first attribute that satisfies a predetermined condition.

The programs or software modules described above may be stored in the computer-readable storage medium on the computer 2000 or in the vicinity of the computer 2000. A recording medium such as a hard disk or a RAM provided in a server system connected to a dedicated communication network or the Internet can be used as the computer-readable storage medium. A program stored in the computer-readable storage medium may be provided to the computer 2000 via a network.

Programs that are installed in the computer 2000 and causes the computer 2000 to function as the assistance apparatus 60 may act on the CPU 2012 or the like to cause the computer 2000 to respectively function as each unit (for example, the assistance control apparatus 200 or the like) of the assistance apparatus 60. When read by the computer 2000, the information processings written in these programs function to implement each unit of the assistance apparatus 60 as a specific means where software and various hardware resources as described above. These specific means implement operations or processing of information according to the intended use of the computer 2000 in the present embodiment, and the assistance apparatus 60 is thereby constructed to be specific for the intended use.

Various embodiments have been described with reference to the block diagrams and the like. In the block diagrams, each block may represent (1) a step of a process in which an operation is executed, or (2) each unit of the apparatus having a role in executing the operation. A specific step and each unit may be implemented by a dedicated circuit, a programmable circuit supplied with computer-readable instructions stored on a computer-readable storage medium, and/or a processor supplied with computer-readable instructions stored on a computer-readable storage medium. The dedicated circuit may include a digital and/or analog hardware circuit, or may include an integrated circuit (IC) and/or a discrete circuit. The programmable circuit may include a reconfigurable hardware circuit including logical AND, logical OR, logical XOR, logical NAND, logical NOR, and another logical operation, and a memory element such as a flip-flop, a register, a field programmable gate array (FPGA), a programmable logic array (PLA), or the like.

The computer-readable storage medium may include any tangible device capable of storing instructions to be executed by an appropriate device. Thereby, the computer-readable storage medium having instructions stored therein forms at least a part of a product including instructions which can be executed to provide means for executing processing procedures or operations specified in the block diagrams. Examples of the computer-readable storage medium may include an electronic storage medium, a magnetic storage medium, an optical storage medium, an electromagnetic storage medium, a semiconductor storage medium, and the like. More specific examples of the computer-readable storage medium may include a floppy (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disc (DVD), a Blu-ray (registered trademark) disc, a memory stick, an integrated circuit card, or the like.

The computer-readable instructions may include an assembler instruction, an instruction-set-architecture (ISA) instruction, a machine instruction, a machine dependent instruction, a microcode, a firmware instruction, state-setting data, or either of source code or object code written in any combination of one or more programming languages including an object oriented programming language such as Smalltalk (registered trademark), JAVA (registered trademark), and C++, and a conventional procedural programming language such as a “C” programming language or a similar programming language.

Computer-readable instructions may be provided to a processor of a general purpose computer, a special purpose computer, or another programmable data processing device, or to programmable circuit, locally or via a local area network (LAN), wide area network (WAN) such as the Internet, and a computer-readable instruction may be executed to provide means for executing operations specified in the described processing procedures or block diagrams. Examples of the processor include a computer processor, a processing unit, a microprocessor, a digital signal processor, a controller, a microcontroller, and the like.

While the present invention has been described by way of the embodiments, the technical scope of the present invention is not limited to the scope described in the above-described embodiments. It is apparent to persons skilled in the art that various alterations or improvements can be made to the above-described embodiments. It is also apparent from description of the claims that the embodiments to which such alterations or improvements are made can be included in the technical scope of the present invention.

The operations, procedures, steps, and stages etc. of each process performed by a device, system, program, and method shown in the claims, specification, or diagrams can be executed in any order as long as the order is not indicated by “before”, “prior to”, or the like and as long as the output from a previous process is not used in a later process. Even if the operation flow is described using phrases such as “first” or “next” for the sake of convenience in the claims, specification, or drawings, it does not necessarily mean that the process must be performed in this order.

### EXPLANATION OF REFERENCES

10: assistance system,
20: vehicle,
40: in-vehicle processing apparatus,
60: assistance apparatus,
70: image-capturing apparatus,
80: user,
82: user terminal,
90: road,
200: assistance control apparatus,
210: user state acquisition unit,
220: walking video information acquisition unit,
270: walking manner identification unit,
230: deceleration information collection unit,
240: storage control unit,
250: information acquisition unit,
260: warning control unit,
280: storage device,
290: communication apparatus,
2000: computer,
2010: host controller,
2012: CPU,
2014: RAM,
2020: input/output controller,
2022: communication interface,
2024: flash memory,
2026: ROM,
2040: input/output chip.

What is claimed is:

1. An assistance control apparatus comprising:
an information acquisition unit that acquires information indicating distance or time that a user, who is a traffic participant, moves after a user terminal associated with the user outputs a warning until movement of the user stops;
a storage control unit that performs control for storing movement information indicating the distance or time that the user moves after the user terminal outputs a warning until movement of the user stops, based on the information acquired by the information acquisition unit; and
a warning control unit that causes the user terminal to output a warning, wherein
the warning control unit adjusts timing to cause the user terminal to output the warning based on the movement information stored by control of the storage control unit.

2. The assistance control apparatus according to claim 1, wherein
the information acquisition unit acquires information indicating distance or time that the user moves after the user terminal outputs a warning until movement of the user stops, acquired by the user terminal after the warning control unit has caused the user terminal to output a warning.

3. The assistance control apparatus according to claim 2, wherein
the information acquisition unit acquires step count information of the user counted by the user terminal after the user terminal outputs a warning until movement of the user terminal stops, acquired by the user terminal after the warning control unit caused the user terminal to output a warning.

4. The assistance control apparatus according to claim 1, further comprising:
a user state acquisition unit that acquires state information indicating whether the user is in a walking state or in a traveling state, wherein
the information acquisition unit acquires, for each of the walking state and traveling state, information indicating distance or time that the user moves after the user terminal outputs a warning until movement of the user stops,
the storage control unit performs control to store movement information based on the information acquired by the information acquisition unit in association with the state information acquired by the user state acquisition unit, and
the warning control unit adjusts timing to cause the user terminal to output a warning based on the movement information stored in association with the state information acquired by the user state acquisition unit.

5. The assistance control apparatus according to claim 1, further comprising:
a user state acquisition unit that acquires state information indicating whether the user is in a state of traveling on a bicycle, wherein
the information acquisition unit acquires information indicating distance or time that the user moves after the user terminal outputs a warning until movement of the user stops, when the user is in a state of traveling on a bicycle,
the storage control unit performs control to store movement information based on the information acquired by the information acquisition unit in association with the state information acquired by the user state acquisition unit, and
the warning control unit adjusts timing to cause the user terminal to output a warning based on the information stored in association with the state information acquired by the user state acquisition unit.

6. The assistance control apparatus according to claim 5, further comprising:
a deceleration information collection unit that collects information indicating a deceleration rate from a state in which the user is traveling on a bicycle until the bicycle stops by braking, wherein
the information acquisition unit acquires information indicating distance or time that the user moves after the user terminal outputs a warning until movement of the user stops, based on a deceleration rate that exceeds a predetermined reference value among the deceleration rates collected by the deceleration information collection unit.

7. The assistance control apparatus according to claim 1, further comprising:
a user state acquisition unit that acquires state information indicating a physical or mental state of the user, wherein
the information acquisition unit acquires, for each of the state information acquired by the user state acquisition unit, information indicating distance or time that the user moves after the user terminal outputs a warning until movement of the user stops,
the storage control unit performs control to store movement information based on the information acquired by the information acquisition unit in association with the state information acquired by the user state acquisition unit, and
the warning control unit adjusts timing to cause the user terminal to output a warning based on the movement information stored in association with the state information acquired by the user state acquisition unit.

8. The assistance control apparatus according to claim 1, wherein
the storage control unit performs control to increase, according to aging of the user, distance indicated by the movement information that is already stored.

9. The assistance control apparatus according to claim 1, further comprising:
a walking video acquisition unit that acquires video information of the user walking; and
a walking manner identification unit that identifies a walking manner of the user identified from the video information acquired by the walking video acquisition unit, wherein
the information acquisition unit acquires distance or time associated with a walking manner of the user identified by the walking manner identification unit, as the information indicating the distance or time.

10. The assistance control apparatus according to claim 2, further comprising:
a user state acquisition unit that acquires state information indicating whether the user is in a walking state or in a traveling state, wherein
the information acquisition unit acquires, for each of the walking state and traveling state, information indicating distance or time that the user moves after the user terminal outputs a warning until movement of the user stops,
the storage control unit performs control to store movement information based on the information acquired by the information acquisition unit in association with the state information acquired by the user state acquisition unit, and
the warning control unit adjusts timing to cause the user terminal to output a warning based on the movement information stored in association with the state information acquired by the user state acquisition unit.

11. The assistance control apparatus according to claim 3, further comprising:
a user state acquisition unit that acquires state information indicating whether the user is in a walking state or in a traveling state, wherein
the information acquisition unit acquires, for each of the walking state and traveling state, information indicating distance or time that the user moves after the user terminal outputs a warning until movement of the user stops,
the storage control unit performs control to store movement information based on the information acquired by the information acquisition unit in association with the state information acquired by the user state acquisition unit, and
the warning control unit adjusts timing to cause the user terminal to output a warning based on the movement information stored in association with the state information acquired by the user state acquisition unit.

12. The assistance control apparatus according to claim 2, further comprising:
a user state acquisition unit that acquires state information indicating whether the user is in a state of traveling on a bicycle, wherein
the information acquisition unit acquires information indicating distance or time that the user moves after the user terminal outputs a warning until movement of the user stops, when the user is in a state of traveling on a bicycle,
the storage control unit performs control to store movement information based on the information acquired by the information acquisition unit in association with the state information acquired by the user state acquisition unit, and
the warning control unit adjusts timing to cause the user terminal to output a warning based on the information stored in association with the state information acquired by the user state acquisition unit.

13. The assistance control apparatus according to claim 3, further comprising:
a user state acquisition unit that acquires state information indicating whether the user is in a state of traveling on a bicycle, wherein
the information acquisition unit acquires information indicating distance or time that the user moves after the user terminal outputs a warning until movement of the user stops, when the user is in a state of traveling on a bicycle,
the storage control unit performs control to store movement information based on the information acquired by the information acquisition unit in association with the state information acquired by the user state acquisition unit, and
the warning control unit adjusts timing to cause the user terminal to output a warning based on the information stored in association with the state information acquired by the user state acquisition unit.

14. The assistance control apparatus according to claim 12, further comprising:
a deceleration information collection unit that collects information indicating a deceleration rate from a state in which the user is traveling on a bicycle until the bicycle stops by braking, wherein
the information acquisition unit acquires information indicating distance or time that the user moves after the user terminal outputs a warning until movement of the user stops, based on a deceleration rate that exceeds a predetermined reference value among the deceleration rates collected by the deceleration information collection unit.

15. The assistance control apparatus according to claim 13, further comprising:
a deceleration information collection unit that collects information indicating a deceleration rate from a state in which the user is traveling on a bicycle until the bicycle stops by braking, wherein
the information acquisition unit acquires information indicating distance or time that the user moves after the user terminal outputs a warning until movement of the user stops, based on a deceleration rate that exceeds a predetermined reference value among the deceleration rates collected by the deceleration information collection unit.

16. The assistance control apparatus according to claim 2, further comprising:
a user state acquisition unit that acquires state information indicating a physical or mental state of the user, wherein
the information acquisition unit acquires, for each of the state information acquired by the user state acquisition unit, information indicating distance or time that the user moves after the user terminal outputs a warning until movement of the user stops,
the storage control unit performs control to store movement information based on the information acquired by the information acquisition unit in association with the state information acquired by the user state acquisition unit, and
the warning control unit adjusts timing to cause the user terminal to output a warning based on the movement information stored in association with the state information acquired by the user state acquisition unit.

17. The assistance control apparatus according to claim 2, wherein
the storage control unit performs control to increase, according to aging of the user, distance indicated by the movement information that is already stored.

18. The assistance control apparatus according to claim 3, wherein
the storage control unit performs control to increase, according to aging of the user, distance indicated by the movement information that is already stored.

19. An assistance control method comprising:
acquiring information indicating distance or time that a user, who is a traffic participant, moves after a user terminal associated with the user outputs a warning until movement of the user stops;
performing control to store movement information indicating distance or time that the user moves after the user terminal outputs a warning until movement of the user stops, based on the information acquired in the acquiring the information; and
adjusting timing to cause the user terminal to output a warning, based on the movement information.

20. A non-transitory computer-readable storage medium having stored thereon a program, the program causing a computer to function as:
an information acquisition unit that acquires information indicating distance or time that a user, who is a traffic participant, moves after a user terminal associated with the user outputs a warning until movement of the user stops;
a storage control unit that performs control for storing movement information indicating the distance or time that the user moves after the user terminal outputs a warning until movement of the user stops, based on the information acquired by the information acquisition unit; and
a warning control unit that causes the user terminal to output a warning, wherein
the warning control unit adjusts timing to cause the user terminal to output the warning based on the movement information stored by control of the storage control unit.
